(19) United States
(12) Patent Application Publication
(10) Pub. No.: US 2008/0255317 A1
(43) Pub. Date: Oct. 16, 2008

(54) Polyester-Polysiloxane Copolymers and Process for their Preparation

(75) Inventors: Oliver Schaefer, Burghausen (DE); Sandra Bachmaier, Eggelsberg (AT)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/091,083

(22) PCT Filed: Oct. 13, 2006
(86) PCT No.: PCT/EP2006/067397

§ 371 Date: Apr. 22, 2008

(30) Foreign Application Priority Data
Oct. 27, 2005 (DE) 10 2005 051 579.7

(51) Int. Cl. C08G 63/91

(52) U.S. Cl. 525/415

(57) ABSTRACT

Polyester/polysiloxane copolymers are prepared by ring-opening synthesis of hydroxyalkyl- or aminoalkyl functional organopolysiloxanes from a cyclic silazane and an Si—OH functional polysiloxane, followed by reaction with a cyclic lactone such as a caprolactone. The process tolerates functional groups on the polysiloxane segments which are not possible in other synthetic methods.

The invention relates to a process for preparing polyester-polysiloxane copolymers.

Polyester-polysiloxane copolymers are known, for example, from patent specifications U.S. Pat. No. 4,663,413, U.S. Pat. No. 4,963,595, and U.S. Pat. No. 5,235,003. Specific embodiments of this class of product are likewise described by Muelhaupt et al. in Angew. Makromol. Chem. 223 (1994) 47-60, Polym. Mater. Sci. Eng. 70 (1993) 4, and J. Appl. Polym. Sci. 54 (6) (1994) 815-26.

The preparation of these products in accordance with the prior art is accomplished by ring-opening polymerization of cyclic esters, such as ε-caprolactone, for example, under the action of catalysts, such as tin salts, for example. Starting products for this preparation are hydroxyalkylsiloxanes or else aminoalkylsiloxanes.

The corresponding hydroxyalkylsiloxanes, for example, can be obtained by equilibration reactions of functional dimers with cyclic siloxanes, or hydrosilylation reactions of Si—H-functional siloxanes of desired architecture and chain length with alkenyl-functional alcohols or amines. In this case the quality of the end product in terms of degree of functionalization, chemical purity, and impurities is heavily dependent on the reaction pathway used.

The equilibration reactions of functional dimers with cyclic siloxanes is feasible only for the amino-functional siloxane reactants. Hydroxy-functional siloxanes, in contrast, cannot be prepared in sufficient purity by way of equilibration reactions, since the equilibration reaction is accompanied by transformation of carbinol groups into Si—O—C groups, with loss of the carbinol function. Siloxanes prepared by this equilibration pathway, furthermore, permit only limited product architectures. Here, therefore, the preparation of siloxane-polyester copolymers with an A-B block structure is not possible.

The hydrosilylation of Si—H-functional siloxanes with alkenyl-functional alcohols or amines, which is used for presently commercially available products, has the disadvantage that the hydrosilylation reaction may be accompanied by secondary reactions involving hydrogen elimination, these reactions leading, with the formation of Si—N—C or Si—O—C groups, to unreactive alkenyl end groups, which are no longer able to initiate ring-opening polymerization of cyclic esters and which therefore lead to a reduction in product quality. A further disadvantage here is that functional groups in the siloxane chain, such as vinyl groups, for example, are not tolerated in this process pathway and, for example, are consumed by reaction with crosslinking.

A further disadvantage of the existing techniques for the preparation of the amino-functional or carbinol-functional siloxanes as starting material for preparing the polycaprolactone-siloxane-polycaprolactones lies in the general use of Si—H functional compounds, which on the one hand do not allow simultaneous use of vinyl-substituted siloxanes but on the other hand, owing to the high price of corresponding Si—H functional silanes or siloxanes as starting compounds, have a distinctly deleterious effect on the preparation costs of the polycaprolactone-siloxane-polycaprolactone end product.

It was an object of the present invention, in the light of the above-described prior art, to provide a process for the preparation of polyester-polysiloxane copolymers that on the one hand is variable in terms of desired polymer structures, such as, A-B or A-B-A block copolymers, for example, and at the same time, where appropriate, is tolerant of the introduction of functional groups, such as alkenyl groups, for example, in the siloxane main chain, and which additionally has economic advantages, yet allows a very high level of chemical purity on the part of the desired products.

Surprisingly it has now been found that the use of aminoalkyl-functional or hydroxyalkyl-functional siloxanes which have been prepared by reacting functional siloxanes or silazanes with Si—OH functional siloxanes meets all of the requirements of a flexible operation which can lead both to A-B-A and to A-B structures and which is also, moreover, tolerant of functional groups in the siloxane chain. The use of the Si—OH functional siloxanes as a siloxane component, which are significantly easier and more cost-effective to prepare, significantly minimizes the preparation expenditures for the polycaprolactone-siloxane-poly-caprolactone end products.

This process for the functionalization of silicones with organofunctional groups has the advantage, furthermore, that it leads not only to aminoalkyl-functional siloxanes, as described, for example, in DE 100 51 886 C1 and DE 103 03 693 A1, but also to hydroxyalkyl-functional compounds, as described, for example, in DE 101 09 842 A1. It is possible here to prepare not only monofunctional siloxanes but also difunctional siloxanes or polyfunctional silicone resins or silicas.

The starting compounds are Si—OH-functional siloxanes, which can be converted easily and in high purity into the desired organofunctional siloxanes. Functional groups, such as vinyl groups, for example, in the siloxane chain are easily obtainable both in the case of hydroxyalkyl-functional siloxanes and in the case of aminoalkyl-functional siloxanes.

At the same time the Si—OH-functional siloxanes used as a reactant are available in large quantities at relatively favorable prices and in a high degree of variability, with the consequence that the siloxanes thus prepared are an ideal building block for the preparation of siloxane-polyester copolymers.

The invention accordingly provides a process for preparing polyester-polysiloxane block copolymers of the general formula (I),

(A)ₐB (I)

in which

a is an integer ≧1,
A denotes a polyester unit of the general formula (II)

H—[O—(CR¹₂)ₙ—CO—]ₘ—X—R²— (II),
in which
a denotes oxygen or NR^{x},
R¹ denotes identical or different, monovalent, substituted or unsubstituted hydrocarbon radicals or hydrogen,
R² denotes divalent, substituted or unsubstituted organic hydrocarbon radicals having 1 to 40 carbon atoms, it being possible for individual carbon atoms to be replaced by oxygen atoms,
R^{x} denotes monovalent, substituted or unsubstituted hydrocarbon radicals having 1 to 20 carbon atoms, it being possible for individual carbon atoms to be replaced by oxygen atoms, or denotes hydrogen or —SiR′₂—R²—NR^{x}, in which R′ denotes identical or different, monovalent, substituted or unsubstituted hydrocarbon radicals,
n denotes an integer from 3 to 10 and
m denotes an integer from 1 to 1000, and
B denotes a polysiloxane unit of the general formula (III)

(R³₂SiO_{2/2})ₚ(R³₃SiO_{1/2})_{q}[O_{1/2}H]ᵣ[O_{1/2}SiR⁴₂]ₜ (III)
in which
R³ denotes identical or different, substituted or unsubstituted, aliphatically saturated or unsaturated, linear, cyclic or branched hydrocarbon or hydrocarbon-oxy radicals having 1 to 20 carbon atoms, or substituted or unsubstituted aromatic hydrocarbon or hydrocarbon-oxy radicals having 6 to 20 carbon atoms,
R⁴ denotes identical or different, substituted or unsubstituted, aliphatically saturated, linear, cyclic or branched hydrocarbon or hydrocarbon-oxy radicals having 1 to 20 carbon atoms, or substituted or unsubstituted aromatic hydrocarbon or hydrocarbon-oxy radicals having 6 to 20 carbon atoms,
p is an integer from 0 to 3000,
q is an integer from 0 to 50,
r is an integer≧0, and
t is an integer≦1,
which through the reaction of cyclic esters of the general formula (IV)

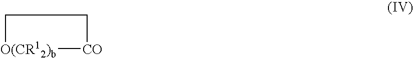

in which R¹ is as defined above and
b denotes an integer from 3 to 10,
with siloxanes of the general formula (V)

(R³₂SiO_{2/2})ₚ(R³₃SiO_{1/2})_{q}[O_{1/2}H]ᵣ[O_{1/2}SiR⁴₂—R²—X—H]ₜ (V)
in which X, R², R³, R⁴, p, q, r, and t are as defined above,

characterized in that the compound of the general formula (V) is prepared through reaction of the compound of the general formula (VI)

(R³₂SiO_{2/2})ₚ(R³₃SiO_{1/2})_{q}[O_{1/2}H]ₛ (VI)

with a cyclic compound of the general formula (VII)

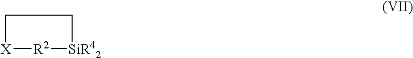

or polymerization products thereof, in which X, R², R³, R⁴, p, and q are as defined above and s is an integer ≧1.

If compounds of the general formula (VII) are used, they react easily and selectively, with good yields, with silanol end groups.

Compounds of the general formula (VII) are stable, are storable, can be synthesized very easily from simple precursors, in accordance, for example, with German laid-open specification DE 15 93 867 A1, and are therefore especially suitable for use on the industrial scale.

The C₁-C₂₀ hydrocarbon radicals and C₁-C₂₀ hydrocarbonoxy radicals R³ and R⁴ may be aliphatically saturated or unsaturated, aromatic, straight-chain or branched. R³ and R⁴ preferably have 1 to 12 atoms, more particularly 1 to 6 atoms, preferably only carbon atoms, or an alkoxy oxygen atom and otherwise only carbon atoms.

Preferably R³ and R⁴ are straight-chain or branched C₁-C₆ alkyl radicals or phenyl radicals. The radicals methyl, ethyl, phenyl, vinyl, and trifluoropropyl are particularly preferred. Preference is given to preparing the compounds of the general formula (V) in which R³ denotes a methyl radical or vinyl radical and R⁴ denotes a methyl radical.

In one preferred embodiment at least one radical R³ or R⁴ in the general formula is an unsaturated alkyl radical having 1 to 6 carbon atoms and with particular preference a vinyl or allyl radical. Hence, for the first time, access is made possible to polyester-polysiloxane block copolymers of the general formula (I) that have unsaturated and hence reactive alkyl radicals in the silicone components. These polyester-polysiloxane block copolymers are likewise provided by this invention and make it possible, for example, for the polyester-polysiloxane block copolymers to be additionally crosslinked in a matrix or on a surface.

Preferably a is selected from the group containing 1 and 2. The inventively prepared compounds of the general formula (I) may be linear or branched.

The values of n are preferably not more than 6 and with particular preference 4 or 5.

Index m preferably has values of not more than 200 and with particular preference values of 1 to 100.

The sum of (p +q +s +t) is preferably a number from 3 to 20 000 and more particularly a number from 5 to 1000.

One preferred embodiment of an organosiloxane of the general formula (III) is a linear silicone polymer with p greater than or equal to 1, q and r equal to 0, and t equal to 2. A further-preferred embodiment for an organosiloxane of the general formula (III) is a linear silicone polymer with p greater than or equal to 1, q equal to 1, r equal to 0, and t equal to 1. The preferred organosiloxanes of the general formula (III) may be distributed either monomodally or multimodally; at the same time they may be present in a narrow or very broad distribution.

The cyclic compound of the general formula (VII) is preferably a five- to seven-membered ring which in addition to its effective synthetic access at the same time also has good reactivity toward silanol groups.

As compounds of the general formula (VII) it is preferred to use compounds of the general formula (VIII)

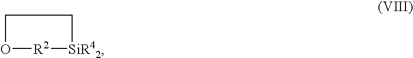

in which

R² and R⁴, and have the above definitions. Preferably here R⁴ is a methyl radical and R² is a divalent propyl or butyl radical, in which a methylene group may be replaced by an oxygen atom. With very particular preference R² is a divalent propyl radical or a divalent —CH₂—CH₂—O—CH₂— radical.

Also preferred as compounds of the general formula (VII) are compounds of the general formula (IX)

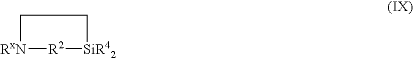

in which

R^{x} and R⁴ have the definitions above and R² preferably represents a divalent propylene or butylene radical. With particular preference R² denotes a divalent propylene radical, R⁴ denotes a methyl radical, and R^{x} denotes hydrogen or an —Si(Me)₂—C₃H₆—NH₂ radical.

The process for the preparation of the compounds of the formula (V) can be carried out without catalysis preferably at temperatures of 0° C. to 200° C. It is preferred, however, to use reaction temperatures of at least 20° C. The process, however, can be further improved by adding certain catalysts. These catalysts are acidic or basic compounds and make it possible for both reaction times and reaction temperatures to be reduced.

The catalyst used in this case is an organic or inorganic Lewis acid or Lewis base, such as, for example, organic Brönstedt acid or base, an organometallic compound or a halide salt. Preferred acids used are carboxylic acids, partially esterified carboxylic acids, more particularly monocarboxylic acids, preferably formic acid or acetic acid, or unesterified or partially esterified mono-, oligo- or polyphosphoric acids. Preferred bases employed are preferably alkylammonium hydroxides, alkylammonium silanolates, ammonium alkoxides, alkylammonium fluorides, amine bases or metal alcoholates or metal alkyls. Preferred metal alcoholates are lithium or sodium alcoholates. Preferred organometallic reagents are organotin compounds, organozinc compounds or alkoxytitanium compounds, or organolithium compounds or grignard reagents. Preferred salts are tetraalkylammonium fluorides.

After the functionalization reaction of the silanol groups, the catalysts used are deactivated preferably by addition of what are called anticatalysts or catalyst poisons, before they can lead to cleavage of the Si—O—Si groups. This secondary reaction is dependent on the catalyst used and need not necessarily occur, so that it may also be possible to forgo deactivation. Examples of catalyst poisons are acids, for example, when using bases, and bases, for example, when using acid, which leads in its end effect to a simple neutralization reaction with corresponding neutralization products, which where appropriate can be filtered off or extracted. Depending on the use of the product, the corresponding reaction product of catalyst with catalyst poison can either be removed from the product or remain in the product.

In the process for the preparation of compounds of the general formula (V) the amount of the compound used with units of the general formula (VII) is dependent on the number r of the silanol groups to be functionalized in the organosiloxane of the general formula (VI). If the desire, however, is to achieve complete functionalization of the OH groups, then the compound with units of the general formula (VII) must be added in at least equimolar amounts. If a compound with units of the general formula (VII) is used in excess, then unreacted compound can subsequently either be distilled off or hydrolyzed and, if desired, likewise distilled off.

This process may be carried out either with solvents included or without the use of solvents, in suitable reactors. It is operated, where appropriate, under reduced pressure or under superatmospheric pressure, or at standard pressure (0.1 MPa).

If solvents are used, preference is given to inert, more particularly aprotic solvents such as aliphatic hydrocarbons, examples being heptane or decane, and aromatic hydrocarbons, examples being toluene or xylene. It is likewise possible to use ethers, such as THF, diethyl ether or MTBE, for example. The amount of solvent should be sufficient to ensure adequate homogenization of the reaction mixture. Solvents or solvent mixtures with a boiling point or boiling range of up to 120° C. at 0.1 MPa are preferred.

The process step for the preparation of the compounds of the formula (I) can be carried out at temperatures of 20° C. to 250° C. Preferably, however, reaction temperatures of at least 50° C. are used. With particular preference first of all some of the cyclic ester is caused to be consumed by reaction at relatively low temperatures of 50° C. to 100° C., so that the organofunctional group on the siloxane of the general formula (V) can be stabilized against thermal degradation by means of the esterification that takes place. After that the temperature is raised, in order to increase the reaction rate, to 100° C. to 200° C. The reaction time is heavily dependent on the catalysts used. Commonly used here are the catalysts that are used in the literature for the synthesis of caprolactone copolymers. These are, especially, organotin compounds, but also alkoxytitanium compounds. Their amount, based on the total amount of the silicone copolymer, is about 20-2000 ppm. Preferably, however, 100-1000 ppm. The reaction time is approximately 0.5 to 48 hours, but preferably 2-10 hours. Subsequently, excess caprolactone or siloxane impurities are separated off by distillation under reduced pressure and at elevated temperature. Preference is given in this case to pressures of below 100 mbar and temperatures of more than 100° C. This process can be carried out either with inclusion of solvents or else without the use of solvents, in suitable reactors. In that case it is operated, where appropriate, under reduced pressure or under superatmospheric pressure, or at standard pressure (0.1 MPa). The process can be carried out continuously or discontinuously.

If solvents are used, preference is given to inert, more particularly aprotic solvents such as aliphatic hydrocarbons, examples being heptane or decane, and aromatic hydrocarbons, examples being toluene or xylene. The amount of solvent should be sufficient to ensure adequate homogenization of the reaction mixture. Solvents or solvent mixtures with a boiling point or boiling range of up to 120° C. at 0.1 MPa are preferred.

All of the above symbols in the above formulae have their definitions in each case independently of one another.

The block copolymers of the present invention display different outstanding properties on adjustment of the degree of polymerization and of the ratio of polysiloxane component to aliphatic polyester block. The block copolymers of the invention may find broad application as they are or as additives in various resins. Owing to the chemical bonding of polysiloxane and aliphatic polyesters, the block copolymers of the invention display surprisingly improved properties in the form of simple mixtures of the parent polymers. Furthermore, they do not show any bleeding effects.

The polyester-polysiloxane copolymer of the invention as it is can be used as an adhesive, as a coating, as cosmetics, as a wax, as textile treatment agents, as an additive to plastics and also in the case of mechanical or electrical components which are required to have a nonabrasive or antislip effect, as protectants with repellent effect, as treatment agents, as a thermally conductive paste together with fillers, as a heat-regulating coating material, as a lubricant, and as an interlayer or outer layer for flat screens, wind-shields, window glass, and safety glass.

The polyester-polysiloxane copolymers of the invention can likewise be used for the majority of known uses of polysiloxanes; on account of their high affinity for base materials, however, as a result of the aliphatic polyester blocks, the polyester-polysiloxane copolymers are mostly superior to the polysiloxanes of the prior art. The superior properties of the polyester-polysiloxane copolymers of the invention are manifested in their solubility in different materials, in the avoidance of bleeding during and after shaping, in the reduction of migration, in the nonabrasive effect, in the gas permeability, in the low bioactive effect, and also, furthermore, in their suitability as a repellent in low-temperature applications, and in their overcoatability.

Where the main constituent of the polyester-polysiloxane copolymers of the invention is an aliphatic polyester block, and where the block copolymer is used as it is, it may be used, for example, in biodegradable resins, as an antithrombotic agent, as an application agent in electroplating, in non-yellowing paints, as an intermediate or surface coating for vehicles, as a binder and/or additive for various paints and coatings, and also as a repellent. The polyester-polysiloxane copolymer of the invention may enhance the surface properties, such as, for example, the water repellency, the nonabrasive effect, the antiblocking, the slip effect, the weather resistance, the gas permeability, and the bio-durability.

Furthermore, the polyester-polysiloxane copolymer of the invention may, as an additive, enhance the properties of various heat-curable resins. Examples of those resins to which the polyester-polysiloxane copolymers can be added as additives are epoxy resins, polyurethanes, polyureas, polyamides, brominated epoxy resins, unsaturated polyester resins, polyester-polyether copolymer, polyimides, melamine resins, phenolic resins, diallyl phthalate resins, and derivatives thereof. Heat-curable resins of this kind, modified with the polyester-polysiloxane copolymers of the invention, have diverse possible applications: for example, as a metal substitute in the automobile industry, as transmission housings or as brush holders, for electrical and electronic parts, as disconnector switches, magnetic switches, collectors, terminal strips, connections, relays, and IFTs, electrical components, such as plugs and ignition-coil caps for automobiles, boats or aircraft, for example, for cladding tools, sports equipment and other equipment, for electrical insulation, as circuit boards, as magnetic tapes, for photographic films, paints, adhesives, and laminating materials, and also as casting compounds. In these utilities, various properties are improved as a result of the addition of the polysiloxane blocks and aliphatic polyester blocks.

Examples of the use of epoxy resins modified with polyester-polysiloxane copolymers of the invention are electrical and electronic components, laminated circuit boards, composite materials, paints, adhesives, structured materials, and anticorrosion applications. The improvement of the material properties of epoxy resins thus modified is manifested more significantly in comparison to the addition of conventional polysiloxanes, owing, among other things, to their high affinity to the epoxy resins. Through the modification of epoxy resins with the polyester-polysiloxane copolymers of the invention it is possible to enhance predominantly the thermal expansion coefficient, the mechanical properties, such as modulus and flexibility, for example, surface tack, fluidity of the composition prior to processing and/or shaping, weather resistance, electrical conductivity, and glass transition temperature, as a result of which release from the mold after shaping, and shaping itself, are significantly improved. Improvements of this kind are important for the use of the epoxy resins in the encapsulation of LEDs, as protective varnishes and coverings, and also as coating material.

Examples of the use of polyurethanes modified with the polyester-polysiloxane copolymers of the invention are thermoplastic elastomers, urethane foams, adhesives, various paints and coatings, urethane fibers and binders—for inks, for example. The polyester-polysiloxane copolymers of the invention have terminal carbinol groups which can react with isocyanates. Accordingly they can also be used as reactants for isocyanates in order to obtain specific properties derived from the polysiloxane blocks and/or aliphatic polyester blocks.

The polyester-polysiloxane copolymer of the invention can be used, furthermore, as an additive for thermoplastic resins. Examples of such thermoplastic resins are polyacrylonitrile, polymethacrylonitrile, polymethyl acrylate, polyacrylamide, polymethacrylate, polymethacrylate esters, and other acrylic resins, polystyrene, polyesters, polyamide, polyesteramide, thermoplastic polyurethanes, polyvinyl chloride, polycarbonate, polyacetal, polyvinylidene chloride, polyvinyl alcohol, and cellulose derivatives. In these systems the polyester-polysiloxane copolymer of the invention improves various properties of the aforementioned thermoplastics, such as, for example, the slip, the heat resistance, the impact resistance, the weather resistance, the gas permeability, the overcoatability, the elasticity, the abrasion resistance, and the demoldability of the resultant moldings from the injection mold or casting mold. On account of the high transparency of the polyester-polysiloxane copolymer of the invention it can be used with preference as an additive for plastics which find use in applications where there are exacting requirements in terms of transparency, such as LEDs or screens, for example.

As an additive in organic thermoplastics, the siloxane-polyester copolymer may also serve as an adhesion-promoting agent to crosslinking silicone rubbers.

In the examples which follow, all quantitative and percentage data, unless indicated otherwise in each case, are given by weight; all pressures are 0.10 MPa (abs.); and all temperatures are 20° C. All viscosities were determined at 25° C.

### EXAMPLES

### Example 1

### Preparation of 2,2-dimethyl-[1,4]dioxa-2-silacyclohexane; Not Inventive

A mixture of 103.9 g (0.75 mol) of chloromethyl-dimethylmethoxysilane, 46.6 g (0.75 mol) of ethylene glycol, and 200 ml of 1,4-diisopropylbenzene was heated to 150° C. and stirred for 3 hours. During this time 24 g (0.75 mol) of methanol were removed by distillation. Thereafter 138.8 g (0.75 mol) of tributylamine were added slowly dropwise at 150° C. The dropwise addition was followed by a further 3 hours of stirring at 150° C. The resulting salt, tributylammonium chloride, was removed by filtration. The filtrate was fractionally distilled twice under standard pressure, with the fraction that goes over at 132° C. affording 26 g of pure 2,2-dimethyl-2-sila-1,4-dioxane (132.23 g/mol, 20 mmol) with a yield of 27%.

### Example 2

20 g (22.3 mmol) of a bishydroxy-terminated poly-dimethylsiloxane having an Mn of 890 g/mol (determined by ¹H-NMR spectroscopy) were reacted at 60° C. with 5.9 g of 2,2-dimethyl-[1,4]dioxa-2-silacyclohexane (44.7 mmol) and 80 mg of lithium methanolate solution (10% strength in methanol) (300 ppm). ¹H-NMR and ²⁹Si-NMR showed that, after 3 hours, all of the OH groups had been converted to hydroxyethyl methyl ether units. This left pure bis(hydroxyethyl methyl ether)-terminated polydimethylsiloxane.

### Example 3

1100 g of a bishydroxy-terminated polydimethylsiloxane having an Mn of 11 000 g/mol (determined by OH number determination) were reacted at 100° C. with 26.7 g (200 mmol) of 2,2-dimethyl-[1,4]dioxa-2-silacyclohexane and 3000 mg of lithium methanolate (10% strength in methanol) (300 ppm). Subsequently the catalyst was neutralized by addition of weakly acidic ion-exchange resin, which thereafter was removed by filtration. ¹H-NMR and 29Si-NMR showed that, after 7 hours, all of the OH groups had been converted to hydroxyethyl methyl ether units. This left pure bis(hydroxyethyl methyl ether) -terminated polydimethylsiloxane.

### Example 4

260 g of a bishydroxy-terminated polydimethylsiloxane having an Mn of 2600 g/mol (determined by ¹H-NMR spectroscopy) were reacted at 80° C. with 26.7 g (200 mmol) of 2,2-dimethyl-[1,4]dioxa-2-silacyclohexane and 900 mg (300 ppm) of lithium methanolate solution (10% strength in methanol). ¹H-NMR and 29Si-NMR showed that, after 4 hours, all of the OH groups had been converted to hydroxyethyl methyl ether units. This left pure bis(hydroxyethyl methyl ether)-terminated poly-dimethylsiloxane.

### Example 5

280 g of a bishydroxy-terminated polydimethylvinyl-siloxane having a vinyl:methyl ratio of 1:4 and having an Mn of 2800 g/mol (determined by ¹H-NMR spectroscopy) were reacted at 80° C. with 26.7 g (200 mmol) of 2,2-dimethyl-[1,4]dioxa-2-silacyclohexane and 900 mg (300 ppm) of lithium methanolate solution (10% strength in methanol). ¹H-NMR and 29Si-NMR showed that, after 4 hours, all of the OH groups had been converted to hydroxyethyl methyl ether units. This left pure bis (hydroxyethyl methyl ether)-terminated polydimethyl-vinylsiloxane.

### Example 6

27 g of a bishydroxy-terminated polymethyltrifluoro-propylsiloxane having a trifluoropropyl:methyl ratio of 1:1 and having an Mn of 900 g/mol (determined by ¹H-NMR spectroscopy) were reacted at 80° C. with 7.9 g (60 mmol) of 2,2-dimethyl-[1,4]dioxa-2-silacyclohexane and 90 mg (300 ppm) of lithium methanolate solution (10% strength in methanol). ¹H-NMR and 29Si-NMR showed that, after 3 hours, all of the OH groups had been converted to hydroxyethyl methyl ether units. This left pure bis(hydroxyethyl methyl ether)-terminated polymethyl-trifluoropropylsiloxane.

### Example 7

33 g of a monohydroxy-terminated polydimethylsiloxane having a molar weight of 1100 g/mol (30 mmol) (determined by ¹H-NMR spectroscopy) were reacted at 80° C. with 4.0 g (30 mmol) of 2,2-dimethyl-[1,4]dioxa-2-silacyclohexane and 120 mg (300 ppm) of lithium methanolate solution (10% strength in methanol). ¹H-NMR and 29Si-NMR showed that, after 3 hours, all of the OH groups had been converted to hydroxyethyl methyl ether units. This left pure mono(hydroxyethyl methyl ether)-terminated polydimethylsiloxane.

### Example 8

1000 g of Me-siloxane (bishydroxy-terminated poly-dimethylsiloxane having an average molecular weight of 3000 g/mol) were reacted at room temperature with 77.2 g of N-((3-aminopropyl)dimethylsilyl)-2,2-di-methyl-[1-aza-2-silacyclopentane. 1H-NMR and 29Si-NMR showed that, after 2 hours, all of the OH groups had been converted to aminopropyl units and there was no longer any residual N-((3-aminopropyl)dimethylsilyl)-2,2-dimethyl-1-aza-2-silacyclopentane detectable.

### Example 9

100 g of Silicon ÖL [Silicone Oil] (bishydroxy-terminated polydimethylsiloxane having an average molecular weight of 13 000 g/mol) were reacted at 50° C. with 1.8 g of N-((3-aminopropyl)dimethylsilyl)-2,2-di-methyl-[1-aza-2-silacyclopentane. 1H-NMR and 29Si-NMR showed that, after 2 hours, all of the OH groups had been converted to aminopropyl units and there was no longer any residual N-((3-aminopropyl)dimethylsilyl)-2,2-dimethyl-1-aza-2-silacyclopentane detectable.

### Example 10

100 g of Silicon ÖL [Silicone Oil] (bishydroxy-terminated polydimethylsiloxane having an average molecular weight of 28 000 g/mol) were reacted at 50° C. with 0.85 g of N-((3-aminopropyl)dimethylsilyl)-2,2-di-methyl-[1-aza-2-silacyclopentane. 1H-NMR and 29Si-NMR showed that, after 2 hours, all of the OH groups had been converted to aminopropyl units and there was no longer any residual N-((3-aminopropyl)dimethylsilyl)-2,2-dimethyl-1-aza-2-silacyclopentane detectable.

### Example 11-22

The respective organofunctional siloxane was mixed with ε-caprolactone (from Solva Caprolactones). Subsequently 500 ppm of dibutyltin dilaurate were added and the reaction mixture was heated to 70° C. with stirring and held at that temperature for 1 hour. Thereafter it was heated to 140° C. and held at that temperature for 6 hours, with stirring. Finally, under a high vacuum (<10 mbar), about 1% to 2% of reaction mixture was removed (siloxane rings and also ε-caprolactone). The copolymer obtained accordingly was finally cooled and granulated. The siloxane content was determined by means of NMR and the molar weights by means of GPC.

| | | | | | Product | |
|---|---|---|---|---|---|---|
| | Siloxane | | ε-Caprolactone | | | Silicone |
| | Amount | From | Amount | Mn | Amount | content |
| Example | [g] | example | [g] | [g/mol] | [g] | [%] |
| 11 | 1000 | 2 | 1000 | 2100 | 1920 | 52 |
| 12 | 1000 | 3 | 1000 | 20 800 | 1930 | 53 |
| 13 | 1000 | 4 | 1000 | 5680 | 1950 | 53 |
| 14 | 1000 | 5 | 1000 | 6150 | 1945 | 51 |
| 15 | 1000 | 6 | 1000 | 2280 | 1970 | 52 |
| 16 | 1000 | 7 | 1000 | 2450 | 1955 | 52 |
| 17 | 1000 | 8 | 1000 | 5710 | 1880 | 54 |
| 18 | 1000 | 4 | 1000 | 4310 | 1425 | 69 |
| 19 | 1000 | 4 | 1000 | 8450 | 2855 | 35 |
| 20 | 1000 | 5 | 500 | 4590 | 1475 | 70 |
| 21 | 100 | 9 | 100 | 24 800 | 180 | 54 |
| 22 | 100 | 10 | 100 | 49 500 | 180 | 55 |

1.-10. (canceled)

11. A process for preparing polyester-polysiloxane block copolymers of the formula (I),
(A)ₐB (I)
in which
a is an integer >1,
A denotes a polyester unit of the formula (II)
H—[O—(CR¹₂)ₙ—CO—]ₘ—X—R²— (II),
in which
X is oxygen or NR^{x},
R¹ are identical or different, monovalent, substituted or unsubstituted hydrocarbon radicals or hydrogen,
R² are divalent, substituted or unsubstituted organic hydrocarbon radicals having 1 to 40 carbon atoms, individual, adjacent carbon atoms optionally replaced by oxygen atoms,
R^{x} are monovalent, substituted or unsubstituted hydrocarbon radicals having 1 to 20 carbon atoms, individual, adjacent carbon atoms optionally replaced by oxygen atoms, and/or are hydrogen or SiR′₂—R²—NR^{x}, in which R′ are identical or different, monovalent, substituted or unsubstituted hydrocarbon radicals,
n is an integer from 3 to 10 and
m is an integer from 1 to 1000, and
B is a polysiloxane unit of the formula (III)
(R³₂SiO_{2/2})ₚ(R³₃SiO_{1/2})_{q}[O_{1/2}H]ᵣ[O_{1/2}SiR⁴₂]ₜ (III)
in which
R³ are identical or different, substituted or unsubstituted, aliphatically saturated or unsaturated, linear, cyclic or branched hydrocarbon or hydrocarbonoxy radicals having 1 to 20 carbon atoms, or substituted or unsubstituted aromatic hydrocarbon or hydrocarbonoxy radicals having 6 to 20 carbon atoms,
R⁴ are identical or different, substituted or unsubstituted, aliphatically saturated, linear, cyclic or branched hydrocarbon or hydrocarbonoxy radicals having 1 to 20 carbon atoms, or substituted or unsubstituted aromatic hydrocarbon or hydrocarbonoxy radicals having 6 to 20 carbon atoms,
P is an integer from 0 to 3000,
q is an integer from 0 to 50,
r is an integer ≧0, and
t is an integer ≧1,
comprising reacting cyclic esters of the formula (IV) 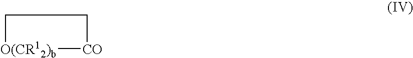
in which R¹ is as defined above and
b denotes an integer from 3 to 10,
with siloxanes of the formula (V)
(R³₂SiO_{2/2})ₚ(R³₃SiO_{1/2})_{q}[O_{1/2}H]ᵣ[O_{1/2}SiR⁴₂—R²—X—H]ₜ (V)
in which X, R², R³, R⁴, p, q, r, and t are as defined above,
with the proviso that the siloxane of the formula (V) is prepared by reacting a compound of the general formula (VI)
(R³₂SiO_{2/2})ₚ(R³₃SiO_{1/2})_{q}[O_{1/2}H]ₛ (VI),
with a cyclic compound of the formula (VII) 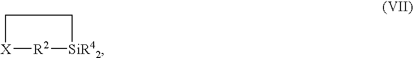
or, or polymerization product thereof, in which X, R², R³, R⁴, p, and q are as defined above and s is an integer ≧1.

12. The process of claim 11, wherein a has the value 1 or 2.

13. The process of claim 11, wherein the sum of (p+q+s+t) is a number from 5 to 1000.

14. The process of claim 11, wherein as a cyclic compound of the formula (VII), a compound of the formula (VIII) 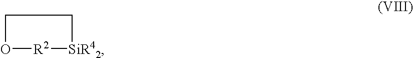
or polymerization product thereof is used, in which
R² is a divalent propyl or butyl radical and
R⁴ is a methyl radical,
wherein in the radicals R² and R⁴ it is possible for a methylene group to be replaced by an oxygen atom.

15. The process of claim 11, wherein as a cyclic compound of the formula (VII) a compound of the general formula (IX) 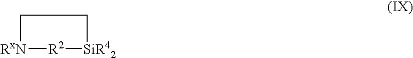
is used, in which
R² is a divalent propylene radical,
R⁴ is a methyl radical, and
R^{x} is hydrogen or a —Si(Me)₂-C₃H₆—NH₂ radical.

16. The process of claim 11, wherein in the process step for the preparation of the compound of the formula (V) a catalyst selected from the group consisting of organic or inorganic Lewis acid or Lewis base, organic Brönstedt acid or base, organometallic compounds or halide salts, is used as a catalyst.

17. The process of claim 11, wherein in the process step for the preparation of the compound of the formula (I) an organotin compound is used as catalyst.

18. The process of claim 11, wherein at least one radical R³ or R⁴ in the formula (III) is an unsaturated alkyl radical having 1 to 6 carbon atoms.

19. The process of claim 18, wherein at least one radical R³ or R⁴ in the formula (III) is a vinyl or allyl radical.

20. A polyester-polysiloxane block copolymer prepared by the process of claim 18.

21. A polyester-polysiloxane block copolymer prepared by the process of claim 19.
